(19) United States
(12) Patent Application Publication
(10) Pub. No.: US 2010/0331021 A1
(43) Pub. Date: Dec. 30, 2010

(54) METHOD AND SYSTEM FOR INTERWORKING BETWEEN INSTANT MESSAGING SERVICE AND SHORT MESSAGE SERVICE

(76) Inventor: William J. Bushnell, St. Charles, IL (US)

Correspondence Address: FAY SHARPE/LUCENT, 1228 Euclid Avenue, 5th Floor, The Halle Building, Cleveland, OH, 44115-1843, US

(21) Appl. No.: 12/494,627

(22) Filed: Jun. 30, 2009

(51) Int. Cl. H04W 4/14

(52) U.S. Cl. 455/466

(57) ABSTRACT

A method and system for interworking between instant messaging and short message service are provided. The invention allows wireless service providers to offer a new text messaging service to their mobile clients, consumer IM clients and to enterprise IM clients. The exemplary embodiments comprise various elements, including a new administrative server that, among other things, allows consumer and enterprise-based IM users to register the URI of their IM client and to request a permanently assigned telephone number for receiving text messages from SMS clients and allows SMS users to register the mobile phone number and to request permanently assigned IM URI. The exemplary embodiments also comprise the expansion of the traditional E.164 Number Mapping (ENUM) server to provide the translation from IM URIs to mobile phone numbers and to perform the translation from mobile phone numbers to IM URIs, and modification of the traditional SMS Gateway to perform ENUM queries.

### BACKGROUND OF THE INVENTION

The exemplary embodiments described herein relate to a method and system for interworking between instant messaging service and short message service. While the embodiments are particularly directed to the art of telecommunications, and will be thus described with specific reference thereto, it will be appreciated that these embodiments may have usefulness in other fields and applications.

By way of background, Instant Messaging (IM) is a form of real-time communication between two or more people based on typed text. IM service can typically be categorized into two types: Enterprise Instant Messaging (EIM) for businesses and Consumer Instant Messaging (CIM) for the general public. With CIM, a public service provider, such as Yahoo or MSN, provides users with clients and access to a network hosted IM server. The text is typically conveyed between clients on devices that are connected over a network such as the Internet. Enterprise solutions such as Microsoft's Office Communicator System or IBM's Lotus Sametime System generally use an IM server that is located in the enterprise's data center and use the enterprise's IP network.

Some CIM service providers allow their clients (or users) to send a text message to a mobile phone client (or user) that has subscribed to Short Message Service (SMS). To send the message, the IM client addresses the message to the phone number of the mobile phone. Because the message is addressed to a telephone number, the message is routed to an SMS Gateway (GW). The SMS GW converts the IM protocol, which is typically based on SIP Instant Message and Presence Leveraging Extension (SIMPLE) (or a derivative there of) to the Short Message Peer to Peer Protocol (SMPP) used by wireless service providers. In addition, the SMS GW replaces the originator's IM Uniform Resource Identifier (URI) (e.g., bill@yahoo.com) with a temporary phone number, which is selected from a pool of numbers. The message is then delivered to the Short Message Service Center (SMSC) of a wireless service provider, which, in turn, forwards the message to the appropriate mobile handset. Since wireless service providers have interconnected their wireless SMS networks, the SMS GW does not need to connect to the wireless network used by the mobile handset subscriber.

When the mobile client receives the message, the mobile client can respond to the text message by replying to the temporary phone number. The SMSC examines the temporary phone number in the response message and routes the response message to the SMS GW. The SMS GW substitutes the temporary phone number with the originator's IM address. The SMS GW also converts the message from SMPP to SIMPLE (or a derivative there of) and forwards the message to the consumer IM service provider.

There are a number of problems, however, with this arrangement. For example, this arrangement does not allow an SMS-based client to initiate a text message to a SIMPLE-based IM client. Additionally, EIM systems (e.g., Microsoft Office Communicator, IBM Lotus Sametime, etc.) have a number of problems that prohibit them from even initiating a text message to a mobile handset. For instance, EIM systems often do not allow Instant Messages to be addressed to telephone-based URIs (e.g., 6302048051@serviceprovider.com). Also, EIM systems do not typically have SMS Gateways. In addition, enterprises cannot secure a pool of temporary numbers that they can assign to interwork IM and SMS text messaging sessions.

Thus, the exemplary embodiments disclosed herein solve these and other problems associated with interworking between IM and SMS.

### SUMMARY OF THE INVENTION

A method and system for interworking between instant messaging service and short message service are provided. The invention allows wireless service providers to offer a new text messaging service to their mobile clients, Consumer IM clients and to Enterprise IM clients that eliminates the problems listed above. The exemplary embodiments comprise various elements, including the following:
A new administrative server that, among other things, allows consumer and enterprise-based IM users to register the URI of their IM client and to request a permanently assigned telephone number for receiving text messages from SMS clients.
Expansion of the traditional E.164 Number Mapping (ENUM) server to provide the translation from IM URIs to mobile phone numbers and to perform the translation from mobile phone numbers to IM URIs.
Modification of the traditional SMS Gateway to perform ENUM queries.

In accordance with aspects of the present invention, a system for interworking between instant messaging (IM) service and short message service (SMS) is provided. The system includes: an SMS gateway that is operatively connected to one or more presence and IM systems and performs E.164 Number Mapping (ENUM) queries; a short message service center (SMSC) that is operatively connected to the SMS Gateway and to an SMS client via a wireless network; an ENUM server that is operatively connected to the SMS gateway and provides a translation from an IM uniform resource identifier (URI) to a wireless phone number and provides a translation from a wireless phone number to an IM URI; and an SMS-IM URI administrative server that is operatively connected to the ENUM server and allows consumer and enterprise-based IM clients to register the URI of the IM client and to request a permanently assigned telephone number for sending and receiving text messages from the SMS client.

Optionally, the SMS gateway and the ENUM server may be combined in a single server or the SMS gateway and the ENUM server may be integrated into the SMSC. Additionally, the SMSC may be adapted to poll the ENUM server to determine whether a phone number in a “To Address” field of an SMS message has been assigned to an IM URI.

In accordance with another aspect of the present invention, a method of providing interworking between instant messaging (IM) service and short message service (SMS) to allow an IM client to receive text messages initiated from an SMS client is provided. The method includes receiving a request from the IM client at an SMS-IM URI administrative server for an assignment of a special phone number for receiving text messages from the SMS client, wherein the IM client has an IM uniform resource identifier (URI). The SMS-URI administrative server responds to the IM client with a permanently assigned telephone number for sending and receiving text messages that is now uniquely associated with the IM client's IM URI. The permanently assigned telephone number for sending and receiving text messages is stored at the SMS URI administrative server and in an E.164 Number Mapping (ENUM) server.

In accordance with yet another aspect of the present invention, a method of providing interworking between instant messaging (IM) service and short message service (SMS) to allow an IM client that cannot address IM messages to phone numbers to initiate a text session with an SMS client is provided. The method includes receiving a request from the SMS client at an SMS-IM URI administrative server for an assignment of an IM uniform resource identifier (URI) for receiving text messages from the IM client. The SMS-URI administrative server responds to the SMS client with a permanently assigned IM URI for receiving text from the IM client, wherein a domain name of the IM URI identifies that the IM messages should be routed to an SMS gateway that supports SMS-IM interworking service. The permanently assigned IM URI for receiving text messages is stored at the SMS-URI administrative server and in an E.164 Number Mapping (ENUM) server.

In accordance with yet another aspect of the present invention, a method of providing interworking between instant messaging (IM) service and short message service (SMS) to allow an SMS client to initiate a text session with an IM client that cannot address IM messages to phone numbers is provided. The method includes receiving a request from the IM client at an SMS-IM URI administrative server for an assignment of a special phone number for receiving text messages from the SMS client, wherein the IM client has an IM uniform resource identifier (URI). The SMS-URI administrative server responds to the IM client with a permanently assigned telephone number for sending and receiving text messages that is now uniquely associated with the IM client's IM URI. The method also includes receiving a request from the SMS client at the SMS-IM URI administrative server for an assignment of an IM URI for receiving text messages from the IM client. The SMS-URI administrative server responds to the SMS client with a permanently assigned IM URI for receiving text from the IM client, wherein a domain name of the IM URI identifies that the IM messages should be routed to an SMS gateway that supports SMS-IM interworking service. The permanently assigned IM URI for receiving text messages and the permanently assigned telephone number for sending and receiving text messages are stored at the SMS URI administrative server and in an E.164 Number Mapping (ENUM) server.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a communication system in which the exemplary embodiments of the invention may be employed;

FIG. 2 is a flow diagram showing a method to enable the IM client to receive a text message that has been initiated by an SMS client;

FIG. 3 is a flow diagram showing a method to enable an enterprise-based IM client that cannot address text messages to phone numbers to initiate a text session with an SMS client; and

FIG. 4 is a flow diagram showing a method to enable an SMS client to initiate a text session with an IM client that cannot address text messages to phone numbers.

### DETAILED DESCRIPTION

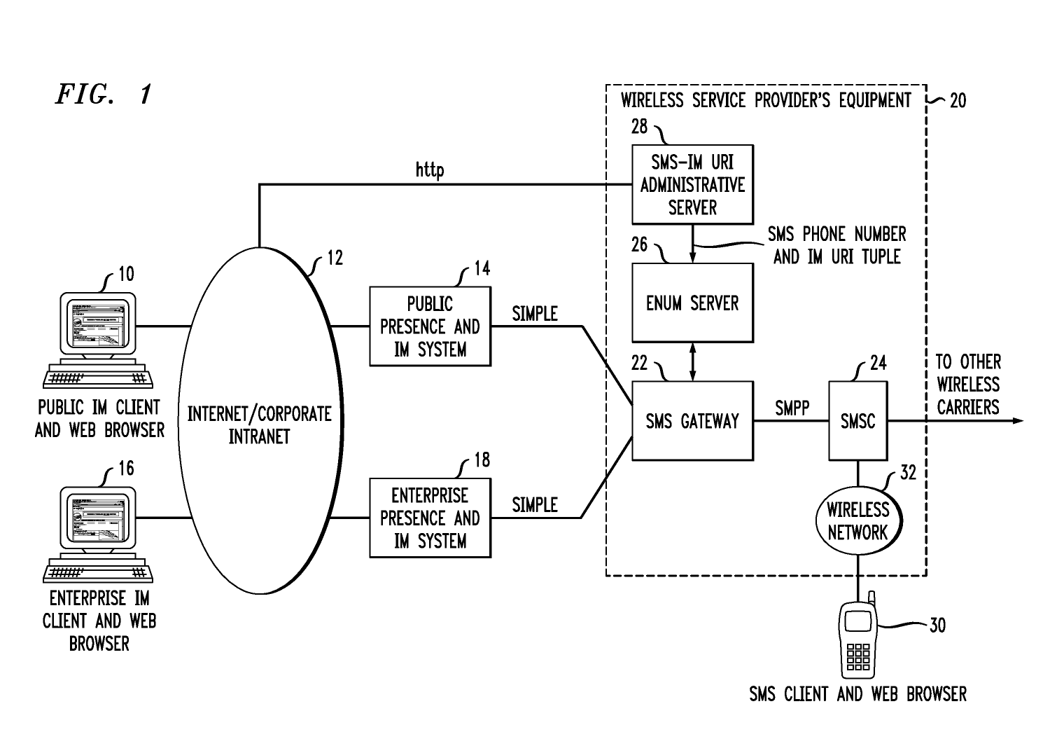

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, FIG. 1 includes at least one consumer IM (CIM) client and web browser 10 connected through one or more networks (e.g., the Internet) 12 to a corresponding consumer presence and IM (CIM) system 14 as well as an enterprise IM (EIM) client and web browser 16 connected through the network(s) 12 to a corresponding enterprise presence and IM (EIM) system 18.

The CIM system 14 and the EIM system 18 may communicate with a wireless service provider 20 that is equipped to provide Short Message Service (SMS) via an SMS gateway (SMS GW) 22 and a Short Message Service Center (SMSC) 24.

The SMS GW 22 suitably acts as a protocol and address interworking gateway between SIMPLE-based IM systems and SMPP-based SMS systems The SMS GW 20 is modified to perform ENUM queries. In this regard, the SMS GW 20 is suitably connected to an ENUM server 26.

An ENUM server generally translates between a telephone number and a uniform resource identifier (URI) which consists of a user ID and Internet Domain Name (e.g., bill@yahoo.com). In this case, the functionality of the ENUM server 26 of FIG. 1 has been expanded to provide the translation from IM URIs to mobile phone numbers and to perform the translation from mobile phone numbers to IM URIs.

The wireless service provider 20 also includes an SMS-IM URI administrative server 28. The SMS-IM URI administrative server 28 allows consumer and enterprise-based IM clients to register the URI of their IM clients and to request a permanently assigned telephone numbers for sending and receiving text messages from SMS clients. Similarly it allows SMS users to register their mobile phone numbers and to request permanently assigned IM URIs (e.g., SMSclient123@wireless-carrier.com).

The SMS GW 20 forwards messages to the SMSC 24, which, in turn, forwards the message(s) to an SMS client/subscriber 30 via a wireless network 32. The SMSC 24 is typically responsible for handling the SMS operations of the wireless service provider 20. When an SMS message is sent from an SMS-enabled device, such as a mobile phone or PDA, used by an SMS client 30, it will reach the SMSC 24 first. The SMSC 24 then forwards the SMS message towards the destination.

An SMS message may need to pass through more than one network entity (e.g., SMSC and SMS gateway) before reaching the destination. The main function of the SMSC 24 is to route SMS messages and regulate the process. If the recipient SMS client is not available, the SMSC 24 may store the SMS message in a database. In that case, the SMSC 24 would forward the SMS message when the SMS client 30 is available. Very often an SMSC is dedicated to handle the SMS traffic of one wireless network. A network operator usually manages its own SMSC(s) and locates them inside its wireless network system. However, it is possible for a network operator to use a third-party SMSC that is located outside the wireless network system.

The various network elements described above generally comprise one or more processor-based devices. These devices execute programs to implement the functionality described herein and generally associated with communication systems. These devices may be specially constructed for the required purposes, or they may comprise one or more general-purpose computers selectively activated or reconfigured by one or more computer programs stored therein. Such computer program(s) may be stored in a computer readable storage medium. As a storage medium for storing the computer program(s), a floppy disk, hard disk, optical disk, magnetic-optical disk, CD-ROM, CD-R, magnetic tape, non-volatile memory card, ROM, or any type of media suitable for storing electronic instructions can be used.

The flexibility of these processor-based devices permits ready integration into these systems of a method of interworking between instant messaging service and short message service in accordance with the present invention. It should be noted, however, that as utilized herein, the term “processor” is not intended to refer exclusively to hardware capable of executing software.

Depending on the capabilities of the applicable IM system the invention operates differently. Furthermore, the invention operates differently for initiating text message sessions from the mobile phone or for initiating the text messages session from the IM client. With reference to FIGS. 1-4, the following sections cover each of above cases separately.

Configuration 1—An IM system such as the CIM system 14 or the EIM system 18 supports addressing IM text messages to a phone number. There are at least two scenarios associated with Configuration 1.

In the first scenario, an IM client such as the CIM client 10 or EIM client 16 wants to send text messages to the SMS client 30. This scenario is supported by capabilities of existing SMS Gateways.

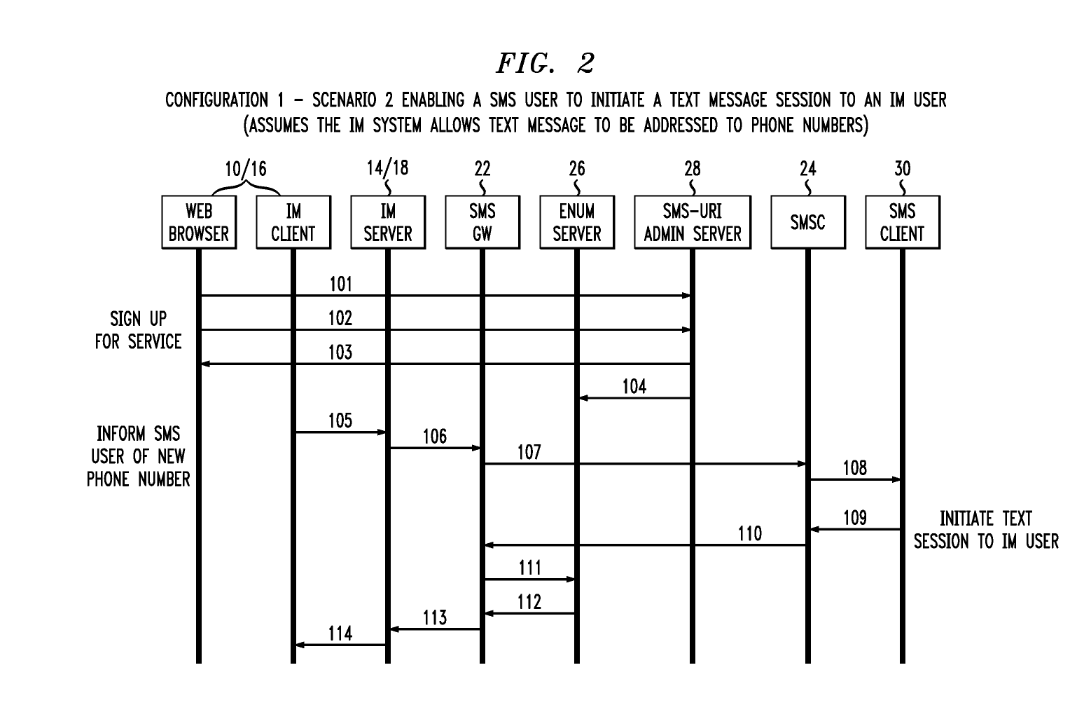

In the second scenario, however, the IM client such as the CIM client 10 or EIM client 16 wants to able to receive text messages such as those that have been initiated by the SMS client 30. With reference to FIG. 2, this scenario begins with the end user activating their web browser and contacting the SMS-IM URI administrative server 28 via the network(s) 12 and requesting the assignment of a special phone number for receiving text messages from SMS-enabled mobile phones such as the SMS client 30 (step 101). Once the user sets up an account on the SMS-IM URI administrative server, the user is asked to enter the IM client's IM URI (e.g., bill@company.com) (step 102). The SMS-URI administrative server 28 then responds with a permanently assigned telephone number for sending and receiving SMS messages (e.g., 222-333-4444) that is now uniquely associated with the IM client's IM URI (step 103). This information is stored at the SMS URI administrative server 28 and in the ENUM server 26 (step 104). The phone numbers are uniquely assigned (based on area code or office code) by the SMS-URI administrative server 28 so that the SMSC 24 in the wireless network can identify that the phone number has a corresponding IM URI and route the text message session to the new SMS GW 22.

The IM client then verbally or via an IM message informs the SMS client 30 of their text messaging phone number (step 105-108). The SMS client 30 can thus initiate a text message to the IM client by composing a text message and addressing the message to the IM client's text messaging phone number (e.g., 222-333-4444). The SMSC 24 receives the text messages from the SMS client 30 (step 109). Based on the destination phone number, the SMSC 24 routes the text message to the SMS GW 22 (step 110).

The SMS GW 22 analyzes the destination phone number and determines that the destination phone number has a corresponding IM URI. The SMS GW 22 sends the destination phone number to the ENUM server 26 (step 111). The ENUM server 26 translates the destination phone number into the IM URI of the IM clients (e.g., bill@company.com) and returns the IM URI to the SMS GW 22 (step 112). The SMS GW 22 translates the SMPP-based text message into a SIMPLE-based text message and inserts the destination IM URI and creates and inserts the originating URI, which consist of the originators mobile phone number and the domain name of the SMS GW 22 (e.g., 222-234-56780@wireless-carder.com). The SMS GW 22 sends the SIMPLE-based text message to the IM Server (step 113), which forwards the message to the IM client via the network(s) 12 (step 114).

The IM client can reply by addressing the reply message to the Originating URI of the received message (e.g., 222-234-5678@wireless-carrier.com).

Configuration 2—An IM system such as the CIM system 14 or the EIM system 18 may not support addressing IM messages to a phone number for an SMS client. In this configuration, there are at least two scenarios.

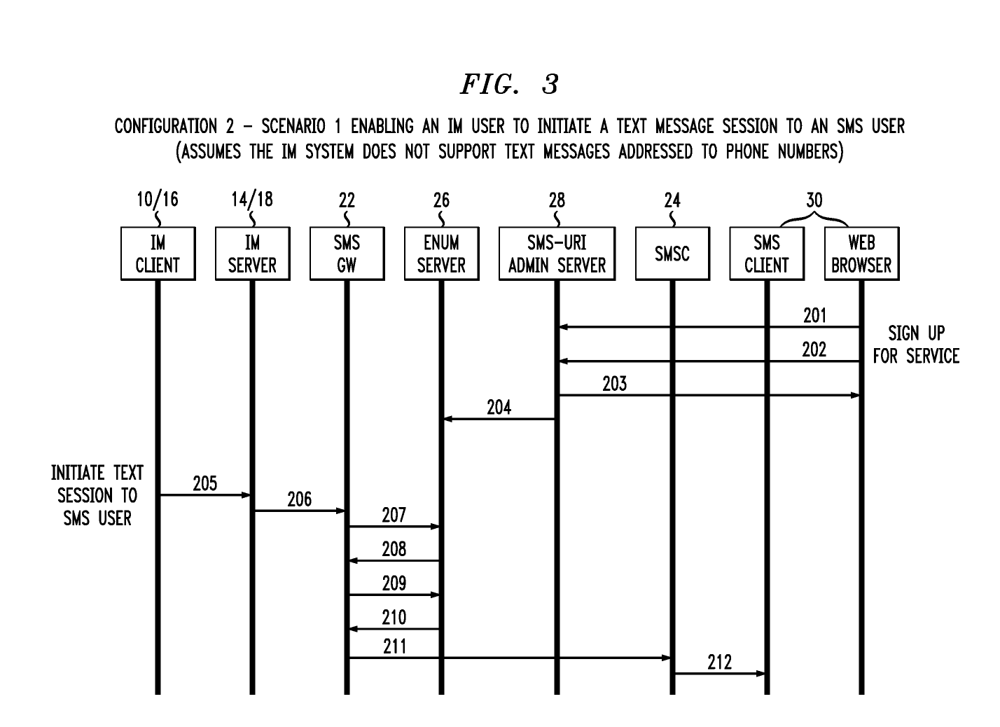

In the first scenario, an IM client such as the CIM client 10 or the EIM client 16 wants to initiate a text session with the SMS client 30. With reference to FIG. 3, this scenario begins with the SMS client using the web browser on their mobile phone 30 to contact the SMS-IM URI administrative server 28 via the Internet and requesting the assignment of an IM URI for receiving text messages from IM clients (step 201). The SMS Subscriber establishes an account on the SMS-IM URI server 28. The SMS-URI administrative server 28 requests the SMS client's mobile phone number (step 202). Based on this information, the SMS URI administrative server 28 responds with a permanently assigned IM URI (e.g., SMSclient123@wireless-carrier.com) for receiving text messages (step 203). The Domain Name of the IM URI (e.g., wireless-carrier.com) identifies that the IM messages should be routed to the SMS GW 22, which supports the new SMS-IM interworking service described herein. The SMS-URI Administrative Server 28 sends the SMS subscriber's phone number and IM URI to the ENUM server 26 (step 204).

The SMS client 30 verbally informs the IM client of their new IM URI. The IM user can then compose and address a text message to the SMS client 30 using the SMS client's IM URI (step 205). The user's IM server launches the SIMPLE-based IM message across the Internet to the SMS GW 22 (step 206). The SMS GW 22 receives the IM message and extracts the destination address (e.g., SMSclient123@wireless-carrier.com). The SMS GW 22 sends the destination IM URI to the ENUM server 26 (step 207). The ENUM server 26 translates the IM URI into the telephone number of the SMS client 30 and sends this information back to the SMS GW 22 (step 208). The SMS GW 22 translates the SIMPLE based IM message to an SMPP-based SMS message and inserts the destination phone number (222-234-5678) into the destination address field of the SMS message. The SMS GW 22 then inserts an origination phone number into the origination address fields of the SMS message. Preferably, the origination phone number is a temporary phone number that the SMS GW 22 assigns from a pool of numbers it manages. Assuming the IM client that initiated the text message also subscribes to the IM-SMS interworking service, then the SMS GW 22 can fetch the originator's permanently assigned text messaging phone number from the ENUM server 26 (steps 209 and 210) and insert that phone number as the originating phone number. The SMS GW 22 then sends the SMS message to the SMSC 24 (step 211), which, in turn, sends the message to the terminating party (step 212).

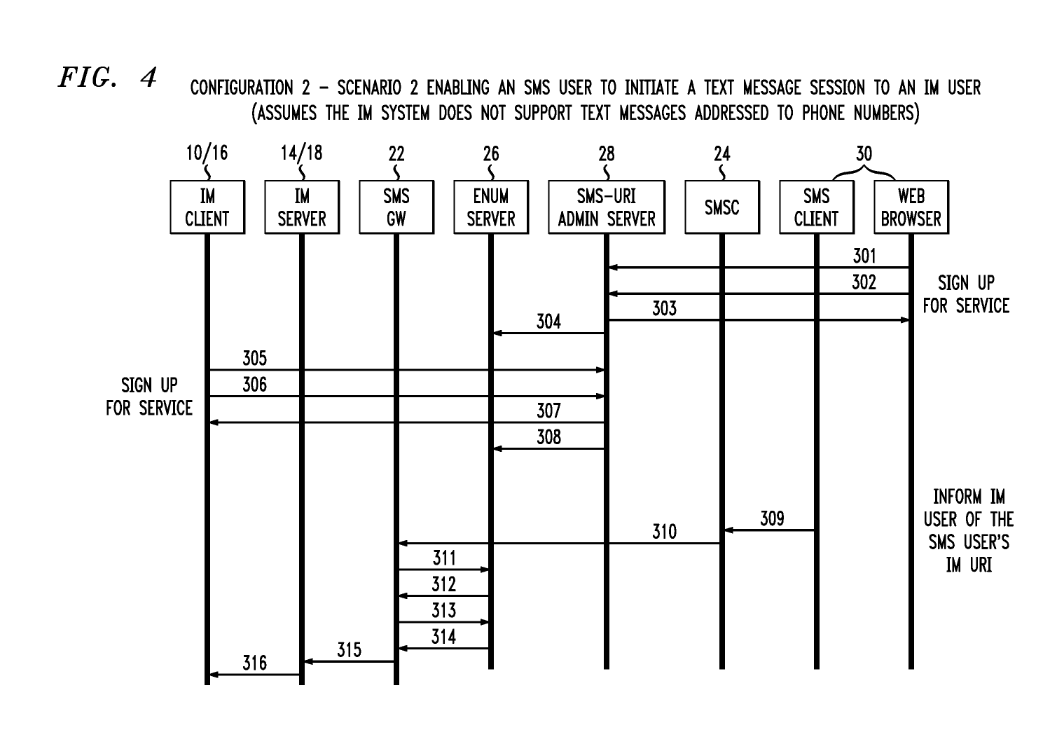

In the second scenario, the SMS client 30 wants to initiate a text session with an IM client such as the CIM client 10 or the EIM client 14. With reference to FIG. 4, in this scenario, both the SMS user and the IM user must contact the SMS-IM URI administrative server 28 and request service in a manner similar to the steps described above (steps 301-303 and 305-307, respectively). The SMS-IM URI administrative server 28 assigns an IM URI to the SMS user's mobile phone number, and the server 28 assigns a mobile phone number to the IM user's IM URI. The SMS user's IM URI is recorded in the ENUM server (step 304) and the IM user's mobile phone number is recorded in the ENUM server 26 (step 308).

The IM user and SMS user verbally exchange the new text message addresses.

The SMS user can now compose an SMS-based text message and address it to the mobile phone number of the IM client (step 309). The SMSC 24 examines the destination address and routes the message to the SMS GW 22 (step 310). The SMS GW 22 sends the destination phone number to the ENUM server 26 (step 311). The ENUM server 26 looks up the destination phone number and returns the IM address (e.g., bill@yahoo.com) to the SMS GW 22 (step 312). Similarly the SMS GW 22 sends the origination phone number to the ENUM server 26 (step 313). The ENUM server 26 then looks up the origination phone number and returns the IM URI for the SMS client 30 (e.g., SMSclient123@wireless-carrier.com) (step 314).

The SMS GW 22 translates the SMPP-based text message to a SIMPLE-based text message and inserts the IM URIs of the originating and terminating parties. The SMS GW 22 then forwards the IM message to the IM client's IM Server (step 315). The IM Server forwards the message to the IM client (step 316) Upon receiving the message, the IM client can respond to the message by using the origination IM URI address received in the initial message as the destination IM URI in the response message.

A number of extensions to the exemplary embodiments described above are contemplated. For example, the wireless service provider 20 can offer an Instant Messaging Service on a new mobile handset and use the above arrangement to interwork text messaging between the legacy SMS-capable handsets and the new IM-capable handsets. The wireless service provider 20 may chose to limit the assignment of IM URIs and SMS phone numbers to only the service provider's IM and SMS customers.

In addition to the standard North American 10 digit telephone number format, the above-described methods and systems can be extended to support other formats (e.g., international dialing formats).

Instead of assigning telephone numbers with a particular format (e.g., a particular area code or series of office codes) the numbers can be randomly selected from the range of numbers available to the wireless service provider. In this case, the SMSC 24 can be enhanced to poll the ENUM server 26 to see if the phone number in the “To Address” field of the SMS message has been assigned to an IM URI. If so, the SMSC 24 can route the SMS message to the SMS GW 22. If the number has not been assigned to an IM client (e.g., CIM client 10 or EIM client 16), the SMSC 24 can provide standard treatment to the SMS message.

The functions of the SMS GW 22 and the ENUM server 26 can be combined in a single server. Optionally, the functions of the SMS GW 22 and ENUM server 26 can also be integrated into the SMSC 24.

This invention can be easily extended to interwork Multimedia Messaging Service (MMS) with IM service provided by a consumer provider or an enterprise based system. Interworking MMS with IM service would allow clients to exchange both text and files (e.g., pictures).

The wireless service provider 20 can allow enterprises to designate their client name and domain names as the client ID assigned to mobile handsets. In particular, if employees of the enterprise have only mobile phones and do not have IM service then the wireless service provider could allow the enterprise to assign unique client IDs for their employees (e.g., bob@company.com). With this arrangement it is easier for the other employees of the company to learn the IM URI of their fellow employees who only have mobile phones.

Some portions of the description below have been presented in terms of algorithms and symbolic representations of operations on data bits performed by computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of these and similar terms are to be associated with the appropriate physical quantities and are merely convenient labels applied to these quantities. Terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system for interworking between instant messaging (IM) service and short message service (SMS), the system comprising:
an SMS gateway that is operatively connected to one or more presence and IM systems and performs E.164 Number Mapping (ENUM) queries;
a short message service center (SMSC) that is operatively connected to the SMS Gateway and to an SMS client via a wireless network;
an ENUM server that is operatively connected to the SMS GW and provides a translation from an IM uniform resource identifier (URI) to a wireless phone number and provides a translation from a wireless phone number to an IM URI; and
an SMS-IM URI administrative server that is operatively connected to the ENUM server and allows consumer and enterprise-based IM clients to register the URI of the IM client and to request a permanently assigned telephone number for sending and receiving text messages from the SMS client and allows SMS-based users to register their phone numbers and to request a permanently assigned IM URI.

2. The system defined in claim 1, wherein the SMS gateway and the ENUM server are combined in a single server.

3. The system defined in claim 1, wherein the SMS gateway and the ENUM server are integrated into the SMSC.

4. The system defined in claim 1, wherein the SMSC is adapted to poll the ENUM server to determine whether a phone number in a “To Address” field of a text message has been assigned to an IM URI.

5. The system defined in claim 1, wherein the system is further adapted to interwork Multimedia Messaging Service (MMS) and SMS.

6. A method of providing interworking between instant messaging (IM) service and short message service (SMS) to allow an IM client to receive text messages from an SMS client, the method comprising:
receiving a request from the IM client at an SMS-IM URI administrative server for an assignment of a special phone number for receiving text messages from the SMS client, wherein the IM client has an IM uniform resource identifier (URI);
the SMS-URI administrative server responding to the IM client with a permanently assigned telephone number for sending and receiving text messages that is now uniquely associated with the IM client's IM URI; and
storing the permanently assigned telephone number for sending and receiving text messages at the SMS URI administrative server and in an E.164 Number Mapping (ENUM) server.

7. The method defined in claim 6, wherein the phone number is uniquely assigned based on area code or office code by the SMS-URI administrative server whereby a short message service center (SMSC) in a wireless network can identify that the phone number has a corresponding IM URI and route a text message session to an SMS gateway.

8. The method defined in claim 7, wherein the SMS gateway and the ENUM server are combined in a single server.

9. The method defined in claim 7, wherein the SMS gateway and the ENUM server are integrated into the SMSC.

10. The method defined in claim 7, wherein the SMSC is adapted to poll the ENUM server to determine whether a phone number in a “To Address” field of a text message has been assigned to an IM URI.

11. The method defined in claim 7, wherein the SMS-URI administrative server and the ENUM server are further adapted to interwork Multimedia Messaging Service (MMS) and SMS.

12. A method of providing interworking between instant messaging (IM) service and short message service (SMS) to allow an IM client that cannot address text messages to phone numbers to initiate a text session with an SMS client, the method comprising:
receiving a request from the SMS client at an SMS-IM URI administrative server for an assignment of an IM uniform resource identifier (URI) for receiving text messages from the IM client;
the SMS-URI administrative server responding to the SMS client with a permanently assigned IM URI for receiving text from the IM client, wherein a domain name of the IM URI identifies that the IM messages should be routed to an SMS gateway that supports SMS-IM interworking service; and
storing the permanently assigned IM URI for receiving text messages at the SMS-URI administrative server and in an E.164 Number Mapping (ENUM) server.

13. The method defined in claim 12, wherein the SMS gateway and the ENUM server are combined in a single server.

14. The method defined in claim 12, wherein the SMS gateway and the ENUM server are integrated into a short message service center (SMSC).

15. The method defined in claim 14, wherein the SMSC is adapted to poll the ENUM server to determine whether an IM URI in a “To Address” field of an IM message has been assigned a mobile phone number.

16. The method defined in claim 12, wherein the SMS-URI administrative server and the ENUM server are further adapted to interwork Multimedia Messaging Service (MMS) and SMS.

17. A method of providing interworking between instant messaging (IM) service and short message service (SMS) to allow an SMS client to initiate a text session with an IM client that cannot address IM messages to mobile phone numbers, the method comprising:
receiving a request from the IM client at an SMS-IM URI administrative sewer for an assignment of a special phone number for receiving text messages from the SMS client, wherein the IM client has an IM uniform resource identifier (URI);
the SMS-URI administrative server responding to the IM client with a permanently assigned telephone number for sending and receiving text messages that is now uniquely associated with the IM client's IM URI receiving a request from the SMS client at the SMS-IM URI administrative server for an assignment of an IM URI for receiving text messages from the IM client;
the SMS-URI administrative server responding to the SMS client with a permanently assigned IM URI for receiving text from the IM client, wherein a domain name of the IM URI identifies that the IM messages should be routed to an SMS gateway that supports SMS-IM interworking service; and
storing the permanently assigned IM URI for receiving text messages and the permanently assigned telephone number for sending and receiving text messages at the SMS URI administrative server and in an E.164 Number Mapping (ENUM) server.

18. The method defined in claim 17, wherein the SMS gateway and the ENUM server are combined in a single server.

19. The method defined in claim 17, wherein the SMS gateway and the ENUM server are integrated into a short message service center (SMSC).

20. The method defined in claim 19, wherein the SMSC is adapted to poll the ENUM server to determine whether a phone number in a “To Address” field of a text message has been assigned to an IM URI.

21. The method defined in claim 17, wherein the SMS-URI administrative server and the ENUM server are further adapted to interwork Multimedia Messaging Service (MMS) and SMS.
